(19) United States
(12) Patent Application Publication
(10) Pub. No.: US 2007/0224627 A1
(43) Pub. Date: Sep. 27, 2007

(54) Facilitation of translocation of molecules through the gastrointestinal tract

(76) Inventors: Lawrence Horowitz, Atherton, CA (US); Ramesh Bhatt, Belmont, CA (US); Aaron Kurtzman, San Carlos, CA (US); Helena Yee, San Francisco, CA (US)

Correspondence Address: HELLER EHRMAN LLP, 275 MIDDLEFIELD ROAD, MENLO PARK, CA, 94025-3506, US

(21) Appl. No.: 11/726,902

(22) Filed: Mar. 23, 2007

Related U.S. Application Data
(60) Provisional application No. 60/785,939, filed on Mar. 23, 2006.

(51) Int. Cl. C40B 50/06; C40B 40/08; C40B 40/10; C40B 30/06

(52) U.S. Cl. 435/6; 435/7.1

(57) ABSTRACT

The invention concerns methods and means for facilitating the translocation of molecules through the gastrointestinal tract of mammals. In particular, the invention concerns methods for identifying antibodies, including antibody fragments, capable of translocation from the lumenal side of gastrointestinal tissue into the blood stream or into the lymphatic circulation. The invention further concerns the identification of sequences within or associated with such antibodies facilitating translocation through the gastrointestinal tract. The invention additionally concerns the use of such antibodies and sequences, or other molecules or moieties identified by using such antibodies or sequences, for facilitating oral delivery and absorption of molecules, such as biomolecules (including proteins and nucleic acids), antibodies, peptides, and non-peptide small molecules.

### CROSS REFERENCE TO RELATED APPLICATION

This application claims priority under 35 U.S.C. § 119(e) from U.S. provisional patent application No. 60/785,939, filed Mar. 23, 2006, the entire contents of which are incorporated by reference.

### FIELD OF THE INVENTION

The present invention concerns methods and means for facilitating the translocation of molecules through the gastrointestinal tract of mammals. In particular, the invention concerns methods for identifying antibodies, including antibody fragments, capable of translocation from the lumenal side of gastrointestinal tissue into the blood stream or into the lymphatic circulation. The invention further concerns the identification of sequences of, within or associated with such antibodies facilitating translocation through the gastrointestinal tract. The invention additionally concerns the use of such antibodies and sequences, or other molecules or moieties identified by using such antibodies or sequences, for facilitating oral delivery and absorption of molecules, such as biomolecules (including proteins and nucleic acids), antibodies, peptides, and non-peptide small molecules.

### BACKGROUND OF THE INVENTION

Despite significant advances in the identification of key mediators of disease progression and in drug discovery technologies, the full therapeutic and commercial potential of antibodies, proteins, and peptides has not been fully realized. Nearly all protein- and peptide-based therapeutics, are administered parenterally because of insufficient absorption from the gastrointestinal tract. This shortcoming seriously limits their use outside of a hospital setting.

Oral delivery of such molecules is hindered by physical barriers, such as poor solubility in the gastrointestinal fluid, and size, charge and hydrophobicity limitations, chemical barriers, such as acid-induced hydrolysis caused by the acidic environment of the gastric fluid, and biochemical barriers, such as enzymes present in the gastrointestinal fluids and endothelia, that result in the break up of proteins into their constituent amino acids or short peptides. Thus, oral absorption of proteins and peptides can be enhanced by chemical modifications; methods increasing hydrophobicity; using various formulation strategies, such as emulsions, microemulsions, nanoparticles, hydrogels, coated liposomes, various polymeric delivery systems; co-administration of protease-inhibitors; absorption enhancers; and targeted delivery. For a review, see., e.g., Mahato et al., Critical Review™ in Therapeutic Drug Carrier Systems, 20(2&3):153-214 (2003).

Recent efforts to enable oral administration of protein- and peptide-based therapeutics additionally include the use of transferrin, a plasma protein found in the blood, that can be fused with protein- and peptide-based drugs to create fusions capable of crossing over into the bloodstream (Lim and Shen, Pharm. Res., 21(11): 1985-92 (2004), and Bai et al., Proc. Natl. Acad. Sci. USA, 102(20):7292:6 (2005)), the use of transferrin receptor antibodies (Qian et al., Pharmacol. Rev., 54(4):561-87 (2002), review article), and via the immunoglobulin pathway, such as, by targeting the neonatal Fc receptor (FcRn) (Low et al., Hum. Reprod., 20(7):1805-13 (2005)), polymeric immunoglobulin receptor (pIgR) (Apodaca and Mostov, J Biol Chem., 268(31):23712-9 (1993); Eckman et al., Am. J. Respir. Cell Mol. Biol., 21(2):246-52 (1999)) or IgA.

Similar delivery issues exist with regard to non-peptide small molecules which show poor solubility or absorption.

The present invention addresses the long standing need for oral delivery of certain molecules, including biomolecules, and protein- and peptide-based therapeutics.

### SUMMARY OF THE INVENTION

In one aspect, the present invention concern a method for identifying molecules capable of translocation through the gastrointestinal tract, comprising:
(a) testing the ability of members of a first repertoire of said molecules to bind to the intestinal epithelium in vitro, and detecting members that are capable of said binding;
(b) testing the ability of members of a second repertoire of said molecules to translocate from the lumenal side of gastrointestinal tissue into the gastrointestinal mucosa or into the blood stream or lymphatic circulation in vivo, and detecting members that are capable of said translocation; and
(c) identifying a member or members detected in step (a) and/or step (b) as being capable of translocation through the gastrointestinal tract,

wherein steps (a) and (b) may be performed simultaneously or in either order.

The molecules can, for example, be antibodies (including antibody fragments), polypeptides, peptides, polynucleotides, and non-peptide small molecules. In a preferred embodiment, the molecules are antibodies, including antibody fragments, and the repertoires tested in steps (a) and (b) are antibody repertoires, which can be the same, overlapping, or different.

The antibody repertoires may be in the form of any type of antibody library, including, without limitation, naive human, recombinant, synthetic and semi-synthetic antibody libraries.

In a particular embodiment, at least one of the antibody libraries is displayed. Display may be performed by any display technique, including, without limitation, phage display, ribosome display, mRNA display, microbial cell display, display on mammalian cells, spore display, viral display, display based on protein-DNA linkage, and microbead display, preferably phage display or spore display.

In another embodiment, in step (a) the ability of the tested molecules, such as antibodies, to bind an epithelial cell line, intestinal epithelial cells or a marker involved in translocation through intestinal epithelium is tested.

When the library tested in step (a) is a phage display library, step (a) can be performed, for example, by in vitro biopanning, while in step (b) members capable of translocation can detected by in vivo phage display in a non-human animal, such as a rodent.

If desired, molecules (such as antibodies) capable of translocation can be isolated, pooled, sequenced, further characterized, and subjected to mutagenesis to improve various properties such as binding or translocation through the gastrointestinal tract.

In other embodiments, the molecules identified as being capable of translocation are used to identify sequences shared by such molecules, and such sequences, and/or consensus sequences based on such sequences are used to create a collection of sequences.

In still other embodiments, the invention concerns antibodies and other molecules identified by the methods herein, as well as chimeric molecules comprising such antibodies or other molecules, or fragments of such antibodies or other molecules, coupled to molecules to be delivered through the gastrointestinal tract.

The invention further provides methods for increasing translocation of molecules through the gastrointestinal tract and methods for oral delivery of poorly absorbing molecules.

### BRIEF DESCRIPTION OF THE DRAWINGS

FIG. 1 is a schematic diagram illustrating a particular embodiment of the method of the invention. LTM=look through mutagenesis; CBM=combinatorial beneficial mutation.

FIG. 2 illustrates that an antibody selected by in vivo phage display binds rat intestinal cells.

### DETAILED DESCRIPTION

A. Definitions

Unless defined otherwise, technical and scientific terms used herein have the same meaning as commonly understood by one of ordinary skill in the art to which this invention belongs. Singleton et al., Dictionary of Microbiology and Molecular Biology 2nd ed., J. Wiley & Sons (New York, N.Y. 1994), provides one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

The term “biomolecule” is used in the broadest sense and refers to any molecule found only in living systems, including proteins, polypeptides, and nucleic acids.

In the context of the present invention, the term “antibody” (Ab) is used in the broadest sense and includes polypeptides which exhibit binding specificity to a specific antigen as well as immunoglobulins and other antibody-like molecules which lack antigen specificity. Polypeptides of the latter kind are, for example, produced at low levels by the lymph system and at increased levels by myelomas. In the present application, the term “antibody” specifically covers, without limitation, monoclonal antibodies, polyclonal antibodies, and antibody fragments.

“Native antibodies” are usually heterotetrameric glycoproteins of about 150,000 daltons, composed of two identical light (L) chains and two identical heavy (H) chains. Each light chain is linked to a heavy chain by covalent disulfide bond(s), while the number of disulfide linkages varies between the heavy chains of different immunoglobulin isotypes. Each heavy and light chain also has regularly spaced intrachain disulfide bridges. Each heavy chain has at one end a variable domain (VH) followed by a number of constant domains. Each light chain has a variable domain at one end (VL) and a constant domain at its other end; the constant domain of the light chain is aligned with the first constant domain of the heavy chain, and the light chain variable domain is aligned with the variable domain of the heavy chain. Particular amino acid residues are believed to form an interface between the light- and heavy-chain variable domains, Chothia et al., J. Mol. Biol., 186:651 (1985); Novotny and Haber, Proc. Natl. Acad. Sci. U.S.A., 82:4592 (1985).

The term “variable” with reference to antibody chains is used to refer to portions of the antibody chains which differ extensively in sequence among antibodies and participate in the binding and specificity of each particular antibody for its particular antigen. Such variability is concentrated in three segments called hypervariable regions both in the light chain and the heavy chain variable domains. The more highly conserved portions of variable domains are called the framework region (FR). The variable domains of native heavy and light chains each comprise four FRs (FR1, FR2, FR3 and FR4, respectively), largely adopting a β-sheet configuration, connected by three hypervariable regions, which form loops connecting, and in some cases forming part of, the β-sheet structure. The hypervariable regions in each chain are held together in close proximity by the FRs and, with the hypervariable regions from the other chain, contribute to the formation of the antigen-binding site of antibodies (see Kabat et al., Sequences of Proteins of Immunological Interest, 5th Ed. Public Health Service, National Institutes of Health, Bethesda, Md. (1991), pages 647-669). The constant domains are not involved directly in binding an antibody to an antigen, but exhibit various effector functions, such as participation of the antibody in antibody-dependent cellular toxicity.

The term “hypervariable region” when used herein refers to the amino acid residues of an antibody which are responsible for antigen-binding. The hypervariable region comprises amino acid residues from a “complementarity determining region” or “CDR” (i.e., residues 24-34 (L1), 50-56 (L2) and 89-97 (L3) in the light chain variable domain and 31-35 (H1), 50-65 (H2) and 95-102 (H3) in the heavy chain variable domain; Kabat et al., Sequences of Proteins of Immunological Interest, 5th Ed. Public Health Service, National Institutes of Health, Bethesda, Md. (1991)) and/or those residues from a “hypervariable loop” (i.e., residues 26-32 (L1), 50-52 (L2) and 91-96 (L3) in the light chain variable domain and 26-32 (H1), 53-55 (H2) and 96-101 (H3) in the heavy chain variable domain; Chothia and Lesk, J. Mol. Biol., 196:901-917 (1987)). “Framework” or “FR” residues are those variable domain residues other than the hypervariable region residues as herein defined.

Depending on the amino acid sequence of the constant domain of their heavy chains antibodies can be assigned to different classes. There are five major classes of antibodies IgA, IgD, IgE, IgG, and IgM, and several of these may be further divided into subclasses (isotypes), e.g., IgG1, IgG2, IgG3, IgG4, IgA, and IgA2.

The heavy-chain constant domains that correspond to the different classes of immunoglobulins are called α, δ, ε, γ, and μ, respectively.

The “light chains” of antibodies from any vertebrate species can be assigned to one of two clearly distinct types, called kappa (κ) and lambda (λ), based on the amino acid sequences of their constant domains.

“Antibody fragments” comprise a portion of a full length antibody, generally the antigen binding or variable domain thereof. Examples of antibody fragments include, but are not limited to, Fab, Fab′, F(ab′)₂, and Fv fragments, linear antibodies, single-chain antibody molecules, diabodies, and multispecific antibodies formed from antibody fragments.

The term “monoclonal antibody” is used to refer to an antibody molecule synthesized by a single clone of B cells. The modifier “monoclonal” indicates the character of the antibody as being obtained from a substantially homogeneous population of antibodies, and is not to be construed as requiring production of the antibody by any particular method. Thus, monoclonal antibodies may be made by the hybridoma method first described by Kohler and Milstein, Nature, 256:495 (1975); Eur. J. Immunol., 6:511 (1976), by recombinant DNA techniques, or may also be isolated from phage antibody libraries.

The term “polyclonal antibody” is used to refer to a population of antibody molecules synthesized by a population of B cells.

“Single-chain Fv” or “sFv” antibody fragments comprise the VH and VL domains of antibody, wherein these domains are present in a single polypeptide chain. Generally, the Fv polypeptide further comprises a polypeptide linker between the VH and VL domains which enables the sFv to form the desired structure for antigen binding. For a review of sFv see Plückthun in The Pharmacology of Monoclonal Antibodies, vol. 113, Rosenburg and Moore eds. Springer-Verlag, New York, pp. 269-315 (1994). Single-chain antibodies are disclosed, for example in WO 88/06630 and WO 92/01047.

The term “diabody” refers to small antibody fragments with two antigen-binding sites, which fragments comprise a heavy chain variable domain (VH) connected to a light chain variable domain (VL) in the same polypeptide chain (VH-VL). By using a linker that is too short to allow pairing between the two domains on the same chain, the domains are forced to pair with the complementary domains of another chain and create two antigen-binding sites. Diabodies are described more fully in, for example, EP 404,097; WO 93/111161; and Hollinger et al., Proc. Natl. Acad. Sci. USA, 90:6444-6448 (1993).

The term “bispecific antibody” refers to an antibody that shows specificities to two different types of antigens. The term as used herein specifically includes, without limitation, antibodies which show binding specificity for a target therapeutic antigen and to another target that facilitates translocation through the gastrointestinal tract. Similarly, multi-specific antibodies have two or more binding specificities.

The expression “linear antibody” is used to refer to comprising a pair of tandem Fd segments (VH-CH1-VH-CH1) which form a pair of antigen binding regions. Linear antibodies can be bispecific or monospecific and are described, for example, by Zapata et al., Protein Eng., 8(10):1057-1062 (1995).

The term “antibody repertoire” is used herein in the broadest sense and refers to a collection of antibodies or antibody fragments which can be used to screen for a particular property, such as binding ability, binding specificity, ability of gastrointestinal transport, stability, affinity, and the like. The term specifically includes antibody libraries, including all forms of combinatorial libraries, such as, for example, antibody phage display libraries, including, without limitation, single-chain Fv (scFv) and Fab antibody phage display libraries from any source, including naive, synthetic and semi-synthetic libraries.

A “phage display library” is a protein expression library that expresses a collection of cloned protein sequences as fusions with a phage coat protein. Thus, the phrase “phage display library” refers herein to a collection of phage (e.g., filamentous phage) wherein the phage express an external (typically heterologous) protein. The external protein is free to. interact with (bind to) other moieties with which the phage are contacted. Each phage displaying an external protein is a “member” of the phage display library.

An “antibody phage display library” refers to a phage display library that displays antibodies or antibody fragments. The antibody library includes the population of phage or a collection of vectors encoding such a population of phage, or cell(s) harboring such a collection of phage or vectors. The library can be monovalent, displaying on average one single-chain antibody or antibody fragment per phage particle or multi-valent displaying, on average, two or more antibodies or antibody fragments per viral particle. The term “antibody fragment” includes, without limitation, single-chain Fv (scFv) fragments and Fab fragments. Preferred antibody libraries comprise on average more than 106, or more than 107, or more than 108, or more than 109 different members.

The term “filamentous phage” refers to a viral particle capable of displaying a heterogenous polypeptide on its surface, and includes, without limitation, f1, fd, Pf1, and M13. The filamentous phage may contain a selectable marker such as tetracycline (e.g., “fd-tet”). Various filamentous phage display systems are well known to those of skill in the art (see, e.g., Zacher et al., Gene, 9:127-140 (1980), Smith et al., Science, 228:1315-1317 (1985); and Parmley and Smith, Gene, 73:305-318 (1988)).

The term “panning” is used to refer to the multiple rounds of screening process in identification and isolation of phages carrying compounds, such as antibodies, with high affinity and specificity to a target.

The term “non-human animal” as used herein includes, but is not limited to, mammals such as, for example, non-human primates, rodents (e.g., mice and rats), and non-rodent animals, such as, for example, rabbits, pigs, sheep, goats, cows, pigs, horses and donkeys. It also includes birds (e.g., chickens, turkeys, ducks, geese and the like). The term “non-primate animal” as used herein refers to mammals other than primates, including but not limited to the mammals specifically listed above.

As used herein, the term “conjugated” means that two participants (e.g., a molecule to be delivered and a molecule or moiety facilitating transcytosis are physically linked by, for example, covalent chemical bonds, physical forces such van der Waals or hydrophobic interactions, encapsulation, embedding, or combinations thereof. In preferred embodiments, the linkage is provided by covalent chemical bonds. As such, preferred chemotherapeutic agents contain a functional group such as an a hydroxyl, carboxy, carbonyl, thiol or amine group to be used in the conjugation to the portion effecting delivery. Specifically, included within the definition are conjugates in which the two components are linked indirectly, though a linker, such as a chain of covalently linked atoms.

The term “translocation” is used in the broadest sense and includes any and all mechanisms by which a molecule can cross from the lumenal side of gastrointestinal tissue into the blood stream or into the lymphatic circulation, including, without limitation, paracellular and transcellular pathways, and active and passive uptake mechanisms. The term specifically includes transcytosis, particulate diffusion through the hydrophobic tight junctions by passive transport, facilitated transcellular diffusion through he lipophilic absorptive cells, and specific transient permeabilization of cells or cell-cell contact junctions.

B. General Techniques

Techniques for performing the methods of the present invention are well known in the art and described in standard laboratory textbooks, including, for example, Ausubel et al., Current Protocols of Molecular Biology, John Wiley and Sons (1997); Molecular Cloning: A Laboratory Manual, Third Edition, J. Sambrook and D. W. Russell, eds., Cold Spring Harbor, N.Y., USA, Cold Spring Harbor Laboratory Press, 2001; O'Brian et al., Antibody Phage Display, Methods and Protocols, Humana Press, 2001; Phage Display: A Laboratory Manual. C. F. Barbas III et al., eds., Cold Spring Harbor, N.Y., USA, Cold Spring Harbor Laboratory Press, 2001; and Antibodies, G. Subramanian, ed., Kluwer Academic, 2004. Mutagenesis can, fore example, be performed using site-directed mutagenesis (Kunkel et al., Proc. Natl. Acad. Sci USA, 82:488-492 (1985)).

The invention is illustrated by describing methods for the selection of antibodies (including antibody fragments) capable of translocation through the gastrointestinal tract, but the methods herein are equally applicable to identify non-antibody molecules with the desired translocation properties.

Furthermore, in the following description, the invention is illustrated with reference to certain types of antibody libraries, but the invention is not limited to the use of any particular type of antibody library. Recombinant monoclonal antibody libraries can be based on immune fragments or naive fragments. Antibodies from immune antibody libraries are typically constructed with VH and VL gene pools that are cloned from source B cells into an appropriate vector for expression to produce a random combinatorial library, which can subsequently be selected for and/or screened. Other types of libraries may be comprised of antibody fragments from a source of genes that is not explicitly biased for clones that bind to an antigen. Thus, naive antibody libraries derive from natural, unimmunized, rearranged V genes. Synthetic antibody libraries are constructed entirely by in vitro methods, introducing areas of complete or tailored degeneracy into the CDRs of one or more V genes. Semi-synthetic libraries combine natural and synthetic diversity, and are often created to increase natural diversity while maintaining a desired level of functional diversity. Thus, such libraries can, for example, be created by shuffling natural CDR regions (Soderlind et al., Nat. Biotechnol., 18:852-856 (2000)), or by combining naturally rearranged CDR sequences from human B cells with synthetic CDR1 and CDR2 diversity (Hoet et al., Nat. Biotechnol., 23:455-38 (2005)).

Similarly, the methods of the present invention are not limited by any particular technology used to display the antibodies. Although the invention is illustrated with reference to phage display, antibodies of the present invention can also be identified by other display and enrichment technologies, such as, for example, ribosome or mRNA display (Mattheakis et al., Proc. Natl. Acad. Sci. USA, 91:9022-9026 (1994); Hanes and Pluckthun, Proc. Natl. Acad. Sci. USA, 94:4937-4942 (1997)), microbial cell display, such as bacterial display (Georgiou et al., Nature Biotech., 15:29-34 (1997)), or yeast cell display (Kieke et al., Protein Eng., 10: 1303-1310 (1997)), display on mammalian cells, spore display (Isticato et al., J. Bacteriol. 183:6294-6301 (2001); Cheng et al., Appl. Environ. Microbiol. 71:3337-3341 (2005) and co-pending provisional application Ser. No. 60/865,574, filed Nov. 13, 2006), viral display, such as retroviral display (Urban et al., Nucleic Acids Res., 33:e35 (2005), display based on protein-DNA linkage (Odegrip et al., Proc. Acad. Natl. Sci. USA, 101:2806-2810 (2004); Reiersen et al., Nucleic Acids Res., 33:e10 (2005)), and microbead display (Sepp et al., FEBS Lett., 532:455-458 (2002)).

In ribosome display, the antibody and the encoding mRNA are linked by the ribosome, which at the end of translating the mRNA is made to stop without releasing the polypeptide. Selection is based on the ternary complex as a whole.

In a mRNA display library, a covalent bond between an antibody and the encoding mRNA is established via puromycin, used as an adaptor molecule (Wilson et al., Proc. Natl. Acad. Sci. USA, 98:3750-3755 (2001)). For use of this technique to display antibodies, see, e.g., Lipovsek and Pluckthun, J. Immunol. Methods., 290:51-67 (2004).

Microbial cell display techniques include surface display on a yeast, such as Saccharomyces cerevisiae (Boder and Wittrup, Nat. Biotechnol., 15:553-557 (1997)). Thus, for example, antibodies can be displayed on the surface of S. cerevisiae via fusion to the α-agglutinin yeast adhesion receptor, which is located on the yeast cell wall. This method provides the possibility of selecting repertoires by flow cytometry. By staining the cells by fluorescently labeled antigen and an anti-epitope tag reagent, the yeast cells can be sorted according to the level of antigen binding and antibody expression on the cell surface. Yeast display platforms can also be combined with phage (see, e.g., Van den Beucken et al., FEBS Lett., 546:288-294 (2003)).

Spore display systems are based on attaching the sequences to be displayed to a coat protein (such as a Bacillus subtilis spore coat protein) or to a toxin-protoxin (such as a Bt protoxin sequence). An advantage of spore display systems is the homogenous particle surface and particle size of non-eukaryotic nature, which is expected to provide an ideal non-reactive background. In addition, the particle size of spores is sufficient to enable selection by flow cytometry that permits selectable clonal isolation, based upon interactions.

The ability of molecules, such as antibodies to bind to the intestinal epithelium can also be tested by a variety of methods, using, as targets, epithelial cells, tissues or cell lines, or antigens displayed on the surface of epithelial cells and identified as being involved in translocation. Such techniques include, for example, all types and configurations of ELISA assays and other binding assays well known in the art.

For a review of techniques for selecting and screening antibody libraries see, e.g., Hoogenboom, Nature Biotechnol., 23(9):1105-1116 (2005).

C. Detailed Description of Preferred Embodiments

In a specific embodiment, the present invention is based on the identification of antibodies, including antibody fragments, capable of assisting translocation of molecules of therapeutic interest through the gastrointestinal tract. By using such antibodies and information gained by identifying such antibodies, the present invention provides methods and means for improving the oral (or central) bioavailability of other poorly absorbed molecules, such as other antibodies, antibody fragments, proteins, peptides and non-peptidic small molecules, following oral administration.

At its simplest, transcytosis is the transport of macromolecular cargo from one side of a cell to the other. The most familiar transcytosis is studied in epithelial tissues, which form cellular barriers between two environments. In this polarized cell type, net movement of material can be in either direction, apical to basolateral or the reverse, depending on the cargo and particular cellular context of the process. For example in intestinal cells transcytosis is a branch of the endocytic pathway, with cargo being internalized via receptor-mediated (i.e., clathrin-coated) mechanisms and progressively sorted away from internalized material destined for other cellular destinations. However, the present invention is not limited by any particular mechanism of translocation through the gastrointestinal tract, rather extends to the facilitation of translocation in general, irrespective of the mechanism involved. Thus, molecules may cross the epithelial layer of the gastrointestinal tract following a variety of routes, including particulate diffusion through the hydrophobic tight junctions by passive transport, facilitated transcellular diffusion through the lipophilic absorptive cells, and active carrier mediated transport or transcytosis. All of these and other routes, as well as their combinations, are specifically included within the scope of the invention herein.

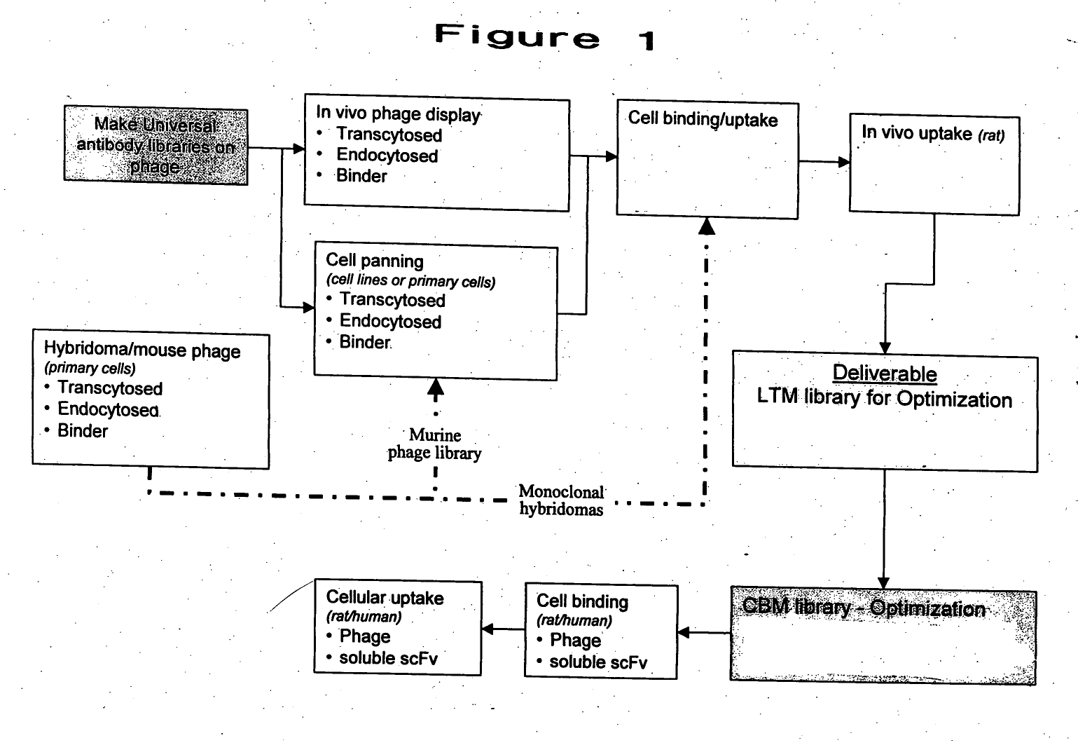

A chart illustrating the steps of a typical method to screen for antibodies capable of translocation through the gastrointestinal tract is shown FIG. 1. It is emphasized, however, that the steps are merely illustrative, and not all steps are absolutely necessary. Additional steps may be included and are within the scope herein.

C.1 Phage Display Antibody Libraries

In a particular embodiment, the present invention utilizes phage display antibody libraries to functionally discover monoclonal antibodies capable of translocation through the gastrointestinal tract. To generate a phage antibody library, a cDNA library is first obtained from mRNA isolated from cells which express a desired antibody repertoire. cDNA copies of the mRNA are produced using reverse transcriptase. cDNA which specifies Ig fragments are obtained by PCR and the resulting DNA is cloned into a suitable bacteriophage vector to generate a bacteriophage DNA library comprising DNA specifying Ig genes. The procedures for making a bacteriophage library comprising heterologous DNA are well known in the art and are described, for example, in textbooks listed above. At present, antibody display on the surface of bacteriophages M13 and fd is the most widespread technique for displaying and selecting antibodies, and for further engineering the antibodies selected. Antibody phage display libraries may contain antibodies in various formats, such as in a single-chain Fv (scFv) or Fab format, and can be derived from the human antibody repertoire. For review see, e.g., Hoogenboom, Methods Mol. Biol., 178:1-37 (2002).

Phage displayed combinatorial antibody libraries include a population of a large number of highly diverse antibodies and this represents a powerful tool for identifying and designing antibodies with desired properties, such as, for example high affinity and specificity. Fully synthetic human combinatorial antibody libraries are particularly important, since human antibodies are best suited for human therapy and avoid both potential issues of immunogenicity and the need for humanization. Such human combinatorial libraries, can be produced without prior immunization by displaying very large and diverse V-gene repertoires on phage (Marks et al., J. Mol. Biol., 222: 581-597 (1991)). Thus, natural VH and VL repertoires present in humans (e.g., human peripheral blood lymphocytes) can be isolated from unimmunized donors by PCR. The V-gene repertoires can be spliced together at random using PCR to create a scFv gene repertoire which can be cloned into a phage vector to create a library of tens of millions to a billion antibodies.

(a) Universal Antibody Library (UAL)—Synthetic Human-Like Repertoire

In the methods of the present invention, the synthetic human antibody repertoire can be represented by a universal antibody library, which can be made by methods known in the art or obtained from commercial sources. Thus, for example, universal immunoglobulin libraries, including subsets of such libraries, are described in U.S. Patent Application Publication No. 20030228302 published on Dec. 11, 2003, the entire disclosure of which is hereby expressly incorporated by reference. In brief, this patent publication describes libraries of a prototype immunoglobulin of interest, in which a single predetermined amino acid has -been substituted in one or more positions in one or more complementarity-determining regions of the immunoglobulin of interest. Subsets of such libraries include mutated immunoglobulins in which the predetermined amino acid has been substituted in one or more positions in one or more of the six complementarity-determining regions of the immunoglobulin in all possible combinations. Such mutations can be generated, for example, by walk-through mutagenesis, as described in U.S. Pat. Nos. 5,798,208, 5,830,650, 6,649,340, and in U.S. Patent Application Publication No. 20030194807, the entire disclosures of which are hereby expressly incorporated by reference. In walk-through mutagenesis, a library of immunoglobulins is generated in which a single predetermined amino acid is incorporated at least once into each position of a defined region, or several defined regions, of interest in the immunoglobulin, such as into one or more complementarity determining regions (CDRs) or framework (FR) regions of the immunoglobulins. The resultant mutated immunoglobulins differ from the prototype immunoglobulin, in that they have the single predetermined amino acid incorporated into one or more positions within one or more regions (e.g., CDRs or FR region) of the immunoglobulin, in lieu of the “native” or “wild-type” amino acid which was present at the same position or positions in the prototype immunoglobulin. The set of mutated immunoglobulins includes individual mutated immunoglobulins for each position of the defined region of interest; thus, for each position in the defined region of interest (e.g., the CDR or FR) each mutated immunoglobulin has either an amino acid found in the prototype immunoglobulin, or the predetermined amino acid, and the mixture of all mutated immunoglobulins contains all possible variants.

Specific sublibraries of antibody heavy and light chains with various mutations can be combined to provide the framework constructs for the antibodies of the present invention, which is followed by introducing diversity in the CDRs of both heavy and light chains. This diversity can be achieved by methods known in the art, such as, for example, by Kunkel mutagenesis, and can be repeated several times in order to further increase diversity. Thus, for example, diversity into the heavy and light chain CDR1 and CD2 regions, separately or simultaneously, can be introduced by multiple rounds of Kunkel mutagenesis. If necessary, the various Kunkel clones can be segregated by CDR lengths and/or clones lacking diversity in a targeted CDR (e.g., CDR1 or CDR3) can be removed, e.g., by digestion with template-specific restriction enzymes. Upon completion of these steps, the size of the library should exceed about 10⁹ members.

(b) Hyperimmunized Murine Antibody Library

In this method, an antibody phage library is rescued from hyperimmunized mice. Specifically, mice (e.g., female BALB/c mice) are immunized and boosted with rat gastric mucosal cells. Mice developing titers of antibody recognizing culture mucosal cells are sacrificed and their spleens harvested. A portion of the splenocytes is used to generate traditional hybridomas as described in detail below, following techniques well known in the art. The mRNA from the remaining splenocytes is used as template for RT-PCR rescue of heavy and light chain repertoires. In a particular embodiment, following the initial PCR rescue of heavy and light chain variable regions, the PCR products are combined with linker oligos to generate scFv libraries to clone directly in frame with M13 pIII coat protein. The library will contain about more than 10⁶, or more than 10⁷, or more than 10⁸, or more than 10⁹ different members, more than 10⁷ different members or above being preferred. As a quality control step, random clones are sequenced in order to assess overall repertoire size and complexity.

In a preferred embodiment, both a universal antibody library (UAL) and a hyperimmunized murine antibody library are used in performing the methods of the present invention. The two libraries are fundamentally different. The UAL is a retrospectively synthesized collection of human-like antibodies that are predicted to bind proteins and peptides, while the murine repertoire is a specific repertoire directed against targeted gastrointestinal cells. The advantage of UAL is that it is designed to contain human-like antibodies, and thus its members can be administered and used in clinical practice without humanization. On the other hand, the murine repertoire can recognize and adapt to numerous components decorating the surface of the gastrointestinal cells. As a result, very different antibodies may be from these methods, and the two methods complement each other, thereby facilitating the identification of antibodies with the desired properties.

C.2 Screening of Phage Display Antibody Libraries

(a) In vivo Phage Antibody Display: Functional Selection

The method of the present invention includes an in vivo phage display step, involving oral administration of human phage antibody libraries to non-human animals, such as mice or rats, and subsequent screening. The advantage of the in vivo display is that the screen demands transport by definition.

In vivo selection systems are known in the art and were originally developed using phage display libraries to identify organ, tissue or cell type targeting peptides in a mouse model system. Intravenous administration of phage display libraries to mice was followed by the recovery of phage from individual organs (Pasqualini and Ruoslahti, Nature, 380:364-366 (1996)). Phage were recovered that were capable of selective homing to the vascular beds of different mouse organs, tissues or cell types, based on the specific targeting peptide sequences expressed on the outer surface of the phage. A variety of organ and tumor-homing peptides have been identified by this method (Koivunen et al., Methods Mol Biol, 129:3-17 (1999)). In addition to identifying individual targeting peptides selective for an organ, tissue or cell, this system has been used to identify endothelial cell surface markers that are expressed in mice in vivo (Rajotte and Rouslahti, J Biol Chem, 274:11593-11598 (1999)), and to identify peptides for oral delivery.

In a particular embodiment of the present invention, phage antibody repertoires (e.g., 10¹¹⁻¹² particles/1 ml of PBS per rat) are orally administered to rats, such as Lewis rats, followed by one or both of two recovery routes. The first route involves recovering phage particles 2-3 hours post administration by mesenteric or portal vein exsanguinations, mesenteric exsanguinations being preferred. The second route is to recover endocytosed phage directly from the mucosal epithelia of the exsanguinated rats. Endocytosed phage particles rescued from mucosal epithelia allow one to rescue antibodies capable of cell entry, but incapable of complete translocation. The reasons for insufficient translocation, could include improper import channels, insufficient time, and/or insufficient release at the basal surface. Most antibodies with poor release properties can be selectively optimized. As an example, if a vesicular route involving reduced pH mediates intracellular transport, one can optimize the antibody clones to release target at low pH through known optimization technologies, such as, for example, look through mutagenesis, saturation mutagenesis, error-prone PCR, and the like, as described below.

In a second delivery route, phage antibody libraries are administered via duodenal cannulation, gut loop model or directly into sections of ligated intestine of rats, such as Lewis rats. This “gastric bypass” protocol has the advantage of avoiding harsh gastric conditions that might otherwise compromise phage stability and diversity, and still maintain the targeted site of action in a functional manner. As described previously phage particles again would be recovered from either exsanguinated blood or directly from mucosal epithelia.

The repertoires obtained by the two different recovery routes may be kept separate or pooled, where pooling is preferably performed only after at least two rounds of selection. Multiple animals can be used to reduce experimental variance and biological bias of phage antibody clones.

(b) In vitro Cell Targeting

In addition to the in vivo selection techniques described above, in vitro selection on gastrointestinal-like mucosal/epithelial cells or cell lines can be used to enrich naïve repertoires or pools. Using an in vitro selection step can accommodate broader species specificity by double selecting transporters that work in both man and rodent.

(b)(1) Cellular Biopanning

In vitro cell biopanning strategy provides several unique advantages for transporter discovery compared to in vivo phage display. The. most obvious advantage is a broader ability to discover, characterize, and optimize selectable characteristics such as affinity and species specificity.

For cellular biopanning both primary cells and cell lines can be used. For example, primary rat (or other mammalian) intestinal mucosal epithelia cells can be cultured and panned. In addition, a variety of cell lines, such as, for example, rat epithelial IEC-6 or human epithelial Caco-2 cell lines can be used. Additionally, other cultured epithelial cells are also suitable, such as, for example, canine MDCK.

The hybrid discovery system of the present invention is of particular value if one needs to reduce the pools or clonal candidates. A hybrid discovery system incorporates selection of antibodies with the desired properties from human and rodent libraries by both in vivo and in vitro approaches, such as in vivo selection of translocated (endocytosed or transcytosed) phage from rats followed by panning on cultured human GI epithelial cells. This hybrid approach shortens the screening process and enables the identification of antibodies with more diverse properties. Thus, in a preferred embodiment, the screening method of the present invention includes an in vivo and an in vitro phage display step, in order to take advantage of both approaches.

(b)(2) Hybridoma

Traditional monoclonal hybridoma strategies are well suited to discover therapeutically relevant antibodies. The hybridoma method is well known and was first described by Koehler and Milstein, Nature, 256:495 (1975).

Briefly, in the hybridoma method, a mouse or other appropriate host animal, such as a hamster or macaque monkey, is immunized to elicit lymphocytes that produce or are capable of producing antibodies that will specifically bind to the antigen used for immunization. Alternatively, lymphocytes may be immunized in vitro. Lymphocytes then are fused with myeloma cells using a suitable fusing agent, such as polyethyleneglycol, to form a hybridoma cell (Goding, Monoclonal Antibodies: Principles and Practice, pp. 59-103 (Academic Press, 1986)). The hybridoma cells obtained are then seeded and grown in a suitable culture medium that preferably contains one or more substances that inhibit the growth or survival of the parental myeloma cells. For example, if the parental myeloma cells lack the enzyme hypoxanthine guanine phosphoribosyl transferase (HGPRT or HPRT), the culture medium for the hybridomas typically will include hypoxanthine, aminopterin, and thymidine (HAT medium), which substances prevent the growth of HGPRT-deficient cells. Preferred myeloma cells are those that fuse efficiently, support stable high-level production of antibody by the selected antibody-producing cells, and are sensitive to a medium such as HAT medium. Among these, preferred myeloma cell lines are murine myeloma lines, such as those derived from MOP-21 and M.C.-11 mouse tumors available from the Salk Institute Cell Distribution Center, San Diego, Calif. USA, and SP-2/0 or X63-Ag8-653 cells available from the American Type Culture Collection, Rockville, Md. USA. Human myeloma and mouse-human heteromyeloma cell lines, such as U266 and RPMI-8226 also have been described for the production of human monoclonal antibodies (Kozbor, J. Immunol., 133:3001 (1984); Brodeuret al., Monoclonal Antibody Production Techniques and Applications, pp. 51-63 (Marcel Dekker, Inc., New York, 1987)). More recently, a hypoxanthine-aminopterin-thymidine-sensitive and ouabain-resistant human myeloma cell line (Karpas 707H) that contains unique genetic markers has been described by Carpas et al., Proc. Natl. Acad. Sci. USA, 98(4): 1799-1804 (2001).

Culture medium in which hybridoma cells are growing is assayed for production of monoclonal antibodies directed against the antigen. Preferably, the binding specificity of monoclonal antibodies produced by hybridoma cells is determined by immunoprecipitation or by an in vitro binding assay, such as radioimmunoassay (RIA) or enzyme-linked immunoabsorbent assay (ELISA).

The binding affinity of the monoclonal antibody can, for example, be determined by the Scatchard analysis of Munson et al., Anal. Biochem., 107:220 (1980).

After hybridoma cells are identified that produce antibodies with the desired properties, the clones may be subcloned by limiting dilution procedures and grown by standard methods (Goding, Monoclonal Antibodies: Principles and Practice, pp. 59-103 (Academic Press, 1986)). Suitable culture media for this purpose include, for example. D-MEM or RPMI-1640 medium. In addition, the hybridoma cells may be grown in vivo as ascites tumors in an animal.

The monoclonal antibodies secreted by the subclones are suitably separated from the culture medium, ascites fluid, or serum by conventional immunoglobulin purification procedures such as, for example, protein A-Sepharose, hydroxylapatite chromatography, gel electrophoresis, dialysis, or affinity chromatography.

In this embodiment of the present invention, translocating antibodies may, for example, be raised by immunizing mice with primary rat mucosal cells from rats, e.g., Lewis rats, or cell lines such as IEC-6, Caco-2, or other mucosal or epithelial cell lines, following the general procedures described above.

In addition to traditional hybridoma screening, murine antibodies can be additionally rescued to phage libraries for screening. These libraries can be biopanned on cells or cell lines to isolate reactive clones, as well as by in vivo phage antibody display described above. Following positive identification and characterization, any promising candidates can be humanized and otherwise optimized by a variety of alternative techniques known in the art, some of which are described below in greater detail.

C.3 Characterization
(a) Phase Clones

Phage clones are monitored and characterized by binding, internalization, and transport assays.

For binding and internalization assessment a variety of techniques, including flow cytometry and cell-based ELISA assays, can be used.

To discriminate between extracellular binding and internalization, phage detection on intact and permeabilized fixed cells can be performed. Flow cytometry may be advantageous in that it can provide greater sensitivity, consistency, and speed.

An in vitro transport assay can be established, for example, by culturing confluent cells to form a barrier upon a permeable support and following phage passage through the cells and permeable support. In addition, functional transport can be monitored by in vivo transport assays.
(b) Recombinant scFv and IgG

To allow the identification of the unique antibody sequence(s) attached to the phage particle, which enable translocation through the gastrointestinal tract, it is necessary to test the antibodies identified as being capable of translocation as purified proteins, such as scFv proteins (Fv proteins) and/or whole immunoglobulins. Methods for the recombinant production and purification of antibodies, including antibody fragments, are well known in the art.

In brief, for recombinant production of an antibody or antibody fragment, the nucleic acid encoding it is isolated and inserted into a replicable vector for further cloning (amplification of the DNA) or for expression. DNA encoding an antibody is readily isolated and sequenced using conventional procedures (e.g., by using oligonucleotide probes that are capable of binding specifically to genes encoding the heavy and light chains of the antibody). Cloning and expression vectors are well known in the art and are commercially available. The vector components generally include, but are not limited to, one or more of the following: a signal sequence, an origin of replication, one or more marker genes, an enhancer element, a promoter, and a transcription termination sequence. Further details of recombinant production of antibodies are discussed in the textbooks referenced above.

Recombinant production of antibodies (including antibody fragments) can be performed in a variety of host cells, including eukaryotic and prokaryotic cells, such as mammalian, bacterial, yeast and plant cells. Of mammalian cells, interest has been greatest in vertebrate cells, including, for example, monkey kidney CV1 line transformed by SV40 (COS-7, ATCC CRL 1651); human embryonic kidney line 293 or 293 cells subcloned for growth in suspension culture (Graham et al., J. Gen Virol., 36:59 (1977)); baby hamster kidney cells (BHK, ATCC CCL 10); Chinese hamster ovary cells/−DHFR (CHO, Urlaub et al., Proc. Natl. Acad. Sci. USA, 77:4216 (1980)); mouse sertoli cells (TM4, Mather, Biol. Reprod., 23:243-251 (1980)); monkey kidney cells (CV1 ATCC CCL 70); African green monkey kidney cells (VERO-76, ATCC CRL-1587); human cervical carcinoma cells (HELA, ATCC CCL 2); canine kidney cells (MDCK, ATCC CCL 34); buffalo rat liver cells (BRL 3A, ATCC CRL 1442); human lung cells (W138, ATCC CCL 75); human liver cells (Hep G2, HB 8065); mouse mammary tumor (MMT 060562, ATCC CCL51); TRI cells (Mather et al., Annals N.Y. Acad. Sci., 383:44-68 (1982)); MRC 5 cells; FS4 cells; and a human hepatoma line (Hep G2).

Suitable prokaryotes include eubacteria, such as Gram-negative or Gram-positive organisms, for example, Enterobacteriaceae such as Escherichia, e.g., E. coli, Enterobacter, Erwinia, Klebsiella, Proteus, Salmonella, e.g., Salmonella typhimurium, Serratia, e.g., Serratia marcescans, and Shigella, as well as Bacilli such as B. subtilis and B. licheniformis, Pseudomonas such as P. aeruginosa, and Streptomyces. One preferred E. coli cloning host is E. coli 294 (ATCC 31,446), although other strains such as E. coli B, E. coli X1776 (ATCC 31,537), and E. coli W3110 (ATCC 27,325) are also suitable.

Antibody purification can also be performed by methods well know in the art, which vary depending on the host and whether the antibody is produced intracellularly, in the periplasmic space, or secreted into the culture medium. Protein A can be used to purify antibodies that are based on human γ1, γ2, or γ4 heavy chains (Lindmark et al., J. Immunol. Meth., 62:1-13 (1983)). Protein G is recommended for all mouse isotypes and for human γ3 (Guss et al., EMBO J., 5:15671575 (1986)).

Cell binding with scFv fragments is directly assessable by flow cytometry or ELISA similar to phage binding described above. However, internalization is expected to require dimeric presentation similar to whole immunoglobulins. Thus, if scFv antibodies are produced, purified and tested, it is preferred to induce dimerization, e.g., by the addition of anti-epitope tag antibodies such as anti-Histidine or anti-myc antibodies, which bind to the C-termini of all scFv constructs, to form a dimeric presentation of the scFv. This is not necessary for phage internalization (described above) because the scFv is likely present on the phage particle in multiple copies, not singly.

For transport assays one can again rely on in vivo testing. In this case, antibodies are best tested as whole immunoglobulins. For this, the best clones identified in the previous steps can be shuttled into a mammalian display system to produce a traditional human heavy and light chain corresponding to such clones. If the clones are from a murine source human/mouse chimeric antibodies can be made (see, e.g., U.S. Pat. No. 4,816,567 and Morrison et al., Proc. Natl. Acad. Sci. USA, 81:6851-6855 (1984)), or the murine antibodies can be humanized by methods known in the art, including the methods developed by Winter and co-workers (Jones et al., Nature, 321:522-525 (1986); Riechmann et al., Nature, 332:323-327 (1988); and Verhoeyen et al., Science, 239:1534-1536 (1988)).

The chimeric approach allows one to more rapidly produce the clone and also more easily track their binding and transport with human specific detection. As an alternative one can prepare scFv as Fc fusions, thus making dimeric proteins in a single cloning step suitable for numerous experimental applications. Such antibodies can, for example, be produced transiently, e.g., in a HEK293 cell culture and purified by standard Protein A purification as described above. Alternatively, these scFvs might be expressed as tetravalent fusions to alkaline phosphatase, thus providing multivalency as well as direct enzymatic detection of uptake and binding.

C.4 Optimization

Following the discovery of an antibody capable of translocation (antibody transporter), its properties, such as specificity, affinity, stability, and other pharmaceutically relevant qualities, can be optimized by mutagenesis methods well known in the art, such as, for example, Look Through Mutagenesis (LTM), as described in US. Patent Application Publication No. 20050136428, published Jun. 23, 2005, the entire disclosure of which is hereby expressly incorporated by reference. Other exemplary mutagenesis methods include saturation mutagenesis and error prone PCR.

Before mutagenesis, it might be advantageous to identify sequences shared among the primary antibodies that were found to have a good ability to translocate through the gastrointestinal tract. These shared sequences, which are likely to play a role in translocation, can be used to generate further antibodies with the expectation of good translocation properties, and as a scaffold to build further combinatorial libraries using mutagenesis techniques, such as those described below. In particular, mutagenesis is designed such that the common amino acid residues or sequences are retained, while the rest of the molecule is subjected to mutagenesis, to produce antibodies (including antibody fragments) with improved properties.

Look-through mutagenesis (LTM) is a multidimensional mutagenesis method that simultaneously assesses and optimizes combinatorial mutations of selected amino acids. The process focuses on a precise distribution within one or more complementarity determining region (CDR) domains and explores the synergistic contribution of amino acid side-chain chemistry. LTM generates a positional series of single mutations within a CDR where each wild type residue is systematically substituted by one of a number of selected amino acids. Mutated CDRs are combined to generate combinatorial single-chain variable fragment (scFv) libraries of increasing complexity and size without becoming prohibitive to the quantitative display of all variants. After positive selection, clones with improved properties are sequenced, and those beneficial mutations are mapped. To identify synergistic mutations for improved translocation properties, combinatorial libraries (combinatorial beneficial mutations, CBMs) expressing all beneficial permutations can be produced by mixed DNA probes, positively selected, and analyzed to identify a panel of optimized scFv candidates. The procedure can be performed in a similar manner with Fv and other antibody libraries.

In optimizing the antibodies of the present invention to improve stability, gastrointestinal stability should be addressed first. This can be approached by biochemically determining the major sites of proteolysis of the lead antibody and apply LTM as described above at and/or around these residues to provide compensatory stability and binding.

One can more readily improve affinity and specificity of antibody binding with knowledge of its cognate target or the target's presence on cell lines. A cell line containing the antibody target can be used to select LTM clones with improved binding and transport characteristics. As previously mentioned, if an antibody is successfully imported but unsuccessfully exported because of insufficient release at the basolateral interface, intracellular release can be engineered into the affinity optimization strategy, by selecting tight binders that elute under intracellular reductive or low pH conditions.

In addition, issues relating to species specificity might be worth optimizing. For example, an excellent rat transporter antibody might minimally recognize the human protein and rather than rescreening human cells for a new antibody to the corresponding human target, one might be able to improve human binding through LTM/CBM. The significant benefit to this approach is a reduction in need for surrogate antibodies in later preclinical testing.

While optimization of antibody properties is illustrated by LTM, as discussed above, other mutagenesis techniques, including, without limitation, saturation mutagenesis and error prone PCR can also be used.

Saturation mutagenesis (Hayashi et al., Biotechniques, 17:310-315 (1994)) is a technique in which all 20 amino acids are substituted in a particular position in a protein and clones corresponding to each variant are assayed for a particular phenotype. (See, also U.S. Pat. Nos. 6,171,820; 6,358,709 and 6,361,974.)

Error prone PCR (Leung et al., Technique, 1:11- 15 (1989); Cadwell and Joyce, PCR Method Applic., 2:28-33 (1992)) is a modified polymerase chain reaction (PCR) technique introducing random point mutations into cloned genes. The resulting PCR products can be cloned to produce random mutant libraries or transcribed directly if a T7 promoter is incorporated within the appropriate PCR primer.

Other mutagenesis techniques are also well known and described, for example, in In Vitro Mutagenesis Protocols, J. Braman, Ed., Humana Press, 2001.

The combinatorial antibody libraries generated by the above-described and other mutagenesis techniques are specifically within the scope of the present invention, and so are the scaffolds and associated information used to build the combinatorial libraries.

C.5 Use of Antibodies Capable of Translocation Through the Gastrointestinal Tract

The antibodies capable of gastrointestinal transport identified by the methods of the present invention can be used directly as therapeutic antibodies, capable of binding to a target antigen. The target antigen can be any polypeptide associated with any disease or pathologic condition, including, without limitation, cancer, inflammation, neurological disorders, cardiovascular disorders, immunological disorders, metabolic disorders, and the like. The antibodies, if generated from a human combinatorial library, may be used directly, or may be humanized or used to prepare chimeric antibodies by methods known in the art, as described above.

In another embodiment, the antibodies of the present invention or fragments thereof are used to transport other (therapeutic) antibodies, peptides, or non-peptide small molecules with poor transport properties. In this case, the antibodies or fragments thereof, are fused to the molecule to be transported, either directly or through appropriate linkers, which are well known in the art. Thus, the transporter antibody and the transported molecule can be linked by bifunctional, hererobifunctional and polyfunctional linkers, including appropriate reactive groups separated by a spacer, which typically consists of 1 to 90 carbon atoms, more preferably 1 to 30 carbon atoms, and yet more preferably 3 to 20 carbon atoms. Heterobifunctional linkers having at least two reactive moieties that can be differentially reacted or activated and reacted are preferred. Another option is to treat the molecule to be joined to the conjugate with reagents that expose a previously hidden or unavailable active group, such as, without limitation, contacting a protein with dithiothreitol (DTT) to expose sulfhydryl moieties, which are suitably reactive. Suitable bifunctional linkers include, but are not limited to, ethylene glycol bis (succininimidylsuccinate), NHS ester, N-(E-maleimidocaproic acid) hydrazide, N-succinimidyl S-acetylthioacetate, and N-succinimidyl S-acetylthiopropionate. Preferred bifunctional linkers include, but are not limited to, N-Succinimidyl S-Acetylthiopropionate, N-Succinimidyl S-Acetylthioacetate, 2-Iminothiolane, 4-Succinimidyloxycarbonyl-Methyl-(2-Pyridyldithio)-Toluene Sulfosuccinimidyl, 4-(N-maleimidomethyl)-cyclohexane-1-carboxylate, N-(gamma-Maleimidobutyryloxy) sulfo-succinimide ester, N-(K-Maleimidoundecanoyloxy) Sulfosuccinimide Ester, Maleimidoacetic Acid N-Hydroxysuccinimide Ester, N-(Epsilon-Maleimidocaproic Acid) Hydrazide, N-(K-Maleimidoundecanoic Acid) Hydrazide, N-(Beta-Maleimidopropionic Acid) Hydrazide, and 3-(2-Pyridyldithio) Propionyl Hydrazide. These and other cross-linking agents are either commercially available or can be readily synthesized.

In a further embodiment, the antibodies are sequenced and common sequences shared by the antibodies capable of gastrointestinal transport are identified. These sequences can be used to transport other molecules, such as antibodies, other polypeptides or proteins, peptides, non-peptide small molecules, thereby enabling their delivery, including, without limitation, oral delivery, delivery to the respiratory tract or into the brain. In addition, the shared sequences can be used to build combinatorial libraries as described above, which in turn can be used to generate further antibodies that can be used similarly to the antibodies identified by the primary screens.

For therapeutic applications, the antibodies or other molecules, the delivery of which is facilitated by using the antibodies or antibody-based transport sequences, are usually used in the form of pharmaceutical compositions. Techniques and formulations generally may be found in Remington's Pharmaceutical Sciences, 18th Edition, Mack Publishing Co. (Easton, Pa. 1990). See also, Wang and Hanson “Parenteral Formulations of Proteins and Peptides: Stability and Stabilizers,” Journal of Parenteral Science and Technology, Technical Report No. 10, Supp. 42-2S (1988). Suitable routes of administration include, without limitation, oral (including buccal, sublingual, inhalation), nasal, rectal, vaginal, and topically.

Compositions for oral administration include powders or granules, suspensions or solutions in water or non-aqueous media, capsules, sachets, troches, tablets or SECs (soft elastic capsules or caplets). Thickeners, flavoring agents, diluents, emulsifiers, dispersing aids, carrier substances or binders may be desirably added to such formulations. Such formulations may be used to effect delivering the compounds to the alimentary canal for exposure to the mucosa thereof. Accordingly, the formulation can consist of material effective in protecting the compound from pH extremes of the stomach, or in releasing the compound over time, to optimize the delivery thereof to a particular mucosal site. Enteric coatings for acid-resistant tablets, capsules and caplets are known in the art and typically include acetate phthalate, propylene glycol and sorbitan monoleate. Formulations suitable for oral administration may be presented as discrete units such as capsules, cachets or tablets each containing predetermined amounts of the active ingredients; as powders or granules; as solutions or suspensions in an aqueous liquid or a non-aqueous liquid; or as oil-in-water emulsions or water-in-oil liquid emulsions. A tablet may be made by compression or molding, optionally with one or more accessory ingredients. Compressed tablets may be prepared by compressing in a suitable machine, the active ingredients in a free-flowing form such as a powder or granules, optionally mixed with a binder, lubricant, inert diluent, preservative, surface active or dispersing agent. Molded tablets may be made by molding in a suitable machine a mixture of the powdered compound moistened with an inert liquid diluent. The tablets may optionally be coated or scored and may be formulated so as to provide slow or controlled release of the active ingredients therein.

The pharmaceutical compositions herein can be converted in a known manner into customary formulations, such as tablets, coated tablets, pills, granules, aerosols, syrups, emulsions, suspensions and solutions, using inert, non-toxic, pharmaceutically suitable excipients or solvents. The therapeutically active compound should in each case be present in amounts sufficient to achieve the desired dosage range, such as, for example in a concentration of about 0.1% to about 99% by weight of the total mixture. The formulations are prepared, for example, by extending the active compounds with solvents and/or excipients, if appropriate using emulsifying agents and/or dispersing agents, and, for example, in the case where water is used as the diluent, organic solvents can be used as auxiliary solvents if appropriate.

Further details of the invention are illustrated by the following non-limiting Examples.

### EXAMPLE 1

### Identification of Antibodies Capable of Translocation Through the Gastrointestinal Tract by In vivo Phase Display

The present Example describes the use of in vivo phage display technology to screen an antibody scFv phage library for clones that specifically pass through the mucosa.

Methods

In vivo Surgical Methods

The following four in vivo surgical methods were investigated to deliver phage into the small intestine of starved male Sprague-Dawley rats:
1. Intraduodenal injections (IDC): Direct injections into the duodenum.
2. Gutloop: An exteriorized section of the ileum was ligated with suture, and the phage library was directly injected into the closed section. The phage was incubated 15 minutes in the rat prior to sacrifice.
3. Intrajejunal cannula (IJC): Rats were surgically implanted with cannulae into the jejunum approximately 5 days prior to dosing. The phage library was injected into the cannula and incubated 15 minutes in the rat prior to sacrifice.
4. Gavage: Rats were administered phage libraries to the stomach by oral gavage. After 2 hours, rats were sacrificed.

Libraries

The libraries used were synthetic UAL scFv libraries, expressed on pIII phage.

General Library Preparation

For round one, the input phage was a native antibody library. For subsequent rounds, a mixture of phage from the previous experiment was prepared, based on the titers from each rat and each tissue. The exchanged library was buffered into PBS by adding 2 ml phage mix to 28 ml sterile PBS using Amicon concentrators. Retentate volumes were about 250 μl. CAM phage (Standard) was added at similar titers as the library phage and the final volume adjusted to approximately 1E11 cfu/ml with PBS for each test subject.

Phage Recovery from Blood and Tissues

About 0.5 g tissue were homogenized in 2 ml DMEM/1xHALT protease inhibitor, 0.25% BSA (DBP) in 15 ml Falcon culture tubes. 2.5 ml DBP+0.5% CHAPS was added to a final concentration of 0.25% CHAPS. All tissue homogenates were kept on ice and mixed every 10 minutes for 1 hour or rotated at 57° C.

To recover phage in tissue homogenates, 1 volume (5 ml) XL1 blue MRF′ (OD600=1) were added and incubated 30 minutes at 37° C., without shaking. Recoveries from liver, spleen and blood were independently measured, by plating small amounts of these infections onto LB-ampicillin/glucose plates to detect library phage titers and LB-chloramphenicol plates to detect standard phage. These ratios were later compared to the ratios found in the input library phage/standard mixes.

To amplify phage for the next round of in vivo phage display, the remaining phage cell mix (about 9 ml) was added to 40 ml 2×YT, 2% glucose, 50 μg/ml ampicillin, and incubated at 37° C. for one hour with vigorous shaking. M13KO7 helper phage was added at MOI 5. Since the number of cells was unknown, an OD600 of 0.3 was assumed. Following infection for 30 minutes (without shaking) at 37° C., the cells were centrifuged, resuspended in 50 ml 2×YT ampicillin/kanamycin, and incubated overnight with shaking. The next morning, the cultures were centrifuged, and the phage in the supernatant collected. The phage were precipitated by addition of ⅕ volume PEG/NaCl and incubated on ice for one hour. Centrifugation was performed at 9000 rpm, 15 minutes, 5° C. and the pellets were resuspended in 3 ml PBS. Supernatants were stored in 50% glycerol at −20° C.

Analysis for Enrichment over Control Phage

To determine enrichment, the ratio of ampicillin resistant cells (infected with phage displaying library clones) to chloramphenicol resistant cells (standard phage) was examined. High ratios support tissues where library clones preferentially crossed the epithelial cell layer.

Sequence Analysis

Colonies were picked and sequenced from tittering plates. Each sequence was translated and aligned.

### SUMMARY OF THE RESULTS

Library to standard phage ratios (as shown in Tables 1A and 1B) were higher in these tissue samples than at administration. This result indicates that library phage advantageously traverse the mucosal epithelium to enter the blood, spleen, and liver as compared to standard phage.

TABLE 1A
Enrichment Results from Gutloop II, Round 2
Phage Ratio = Library/Standard
Gutloop II, Rd 2

| | Test | | | |
|---|---|---|---|---|
| | subject | Liver | Spleen | Blood |
| Input | 1 | 4.7 | 5.8 | 16.3 |
| 2.05 | 2 | 2.9 | 8.9 | 6.3 |
| | 3 | 4.9 | 9.3 | ND |

TABLE 1B
Enrichment Results from Gutloop II, Round 2
IJC-I, Round 1

| | Test | | | |
|---|---|---|---|---|
| | subject | Liver | Spleen | Blood |
| Input | 1 | 11.6 | 16.1 | ND |
| 2.50 | 2 | 4.1 | 8.2 | ND |
| | 3 | 8.0 | 15.0 | ND |

The sequences of clones identified by the foregoing in vivo selection are shown below:

| | |
|---|---|
| MAQVQLVQSGAEVKKPGSSVKVSCKASGGTFSSY | (SEQ ID NO: 1) |
| AISWVRQAPGQGLEWMGGIIPIFGTANYAQKFQG | |
| RVTITADKSTSTAYMELSSLRSEDTAVYYCARAG | |
| STAFDYWGQGTLVTVSSGGGGSGGGGSGGGGSNI | |
| QMTQSPSSLSASVGDRVTITCRASQGISNYLAWF | |
| QQKPGKAPKSLIYAASSLQSGVPSRFSGSGSGTD | |
| FTLTISSLQPEDFATYYCQQYNRPPRTFGQGTKV | |
| EIKRTASGAAAAHHHHHH | |
| MAEVQLLESGGGLVQPGGSLRLSCAASGFTFSSY | (SEQ ID NO: 2) |
| AMSWVRQAPGKGLEWVSAISGSGGSTYYADSVKG | |
| RFTISRDNSKNTLYLQMNSLRAEDTAVYYCARGG | |
| SGGFDYWGQGTLVTVSSGGGGSGGGGSGGGGSEI | |
| VLTQSPGTLSLSPGERATLSCRASQSVSSSYLAW | |
| YQQKPGQAPRLLIYGASSRATGIPDRFSGSGSGT | |
| DFTLTISRLEPEDFAVYYCQQYASTPVTFGQGTK | |
| VEIKRTASGAAAAHHHHHH | |
| MAQVQLVQSGAEVKKPGSSVKVSCKASGGTFSSY | (SEQ ID NO: 3) |
| TMSWVRQAPGQGLEWMGDINPNNGTANYAQKFQG | |
| RVTITADKSTSTAYMELSSLRSEDTAVYYCARGR | |
| AATFDYWGQGTLVTVSSGGGGSGGGGSGGGGSNI | |
| QMTQSPSSLSASVGDRVTITCRASQGISSYLDWY | |
| QQKPGKAPKLLIYHASYLQSGVPSRFSGSGSGTD | |
| FTLTISSLQPEDFATYYCQQYNIIPITFGQGTKV | |
| EIKRTASGAAAAHHHHHH | |
| MAQVQLVQSGAEVKKPGSSVKVSCKASGGTFSSY | (SEQ ID NO: 4) |
| AISWVRQAPGQGLEWMGGIIPIFGTANYAQKFQG | |
| RVTITADKSTSTAYMELSSLRSEDTAVYYCARRG | |
| RGRFDYWGQGTLVTVSSGGGGSGGGGSGGGGSEI | |
| VLTQSPGTLSLSPGERATLSCRASQSVSSAYLAW | |
| YQQKPGQAPRLLIYGASSRATGIPDRFSGSGSGT | |
| DFTLTISRLEPEDFAVYYCQQYAAAPPPTFGQGT | |
| KVEIKRTASGAAAAHHHHHH | |
| MAEVQLLESGGGLVQPGGSLRLSCAASGFTFSSY | (SEQ ID NO: 5) |
| DMNWVRQAPGKGLEWVSAISGSGGSTYYADSVKG | |
| XFTISRDNSKNTLYLQMNSLRAEDTAVYYCARVI | |
| GVVFFDFXYWXQGTLVTXSSGGGGSGGGGSGGGG | |
| SDIQMTQSPSSLSASVGDRVTITCRASQGISSYL | |
| TWYQQKPGKAPKSLIYAASSLQSGVPSXFSGSGS | |
| GTDFTLTISSLQPEDFXTYYCQQYNSNPLTFGQG | |
| TKVEIKRTASGAAAAHHHHHH | |
| MAEVQLLESGGGLVQPGGSLRLSCAASGFTFSSY | (SEQ ID NO: 6) |
| AMSWVRQAPGKGLEWVSAISGSGGSTYYADSVKG | |
| RFTISRDNSKNTLYLQMNSLRAEDTAVYYCARGD | |
| SSGDDFDYWGQGTLVTVSSGGGGSGGGGSGGGGS | |
| EIVLTQSPGTLSLSPGERATLSCRASQSVSNSYL | |
| AWYQQKPGQAPRLLIYGASPRATGIPDRFSGSGS | |
| GTDFTLTISRLEPEDFAVYYCQQYNSTPSTFGQG | |
| TKVEIKRTASGAAAAHHHHHH | |
| MAQVQLVQSGAEVKKPGSSVKVSCKASGGTFSSY | (SEQ ID NO: 7) |
| AMAWVRQAPGQGLEWMGDIDPDSGATNYAQKFQG | |
| RVTITADKSTSTAYMELSSLRSEDTAVYYCARPG | |
| ARAHSFDYWGQGTLVTVSSGGGGSGGGGSGGGGS | |
| EIVLTQSPGTLSLSPGERATLSCRASQSVSSSYL | |
| AWYQQKPGQAPRLLIYGASSRATGIPDRFSGSGS | |
| GTDFTLTISRLEPEDFAVYYCQQYHPPPPPTFGQ | |
| GTKVEIKRTASGAAAAHHHHHH | |
| MAQVQLVQSGAEVKKPGSSVKVSCKASGGTFSSY | (SEQ ID NO: 8) |
| AISWVRQAPGQGLEWMGGIIPIFGTANYAQKFQG | |
| RVTITADKSTSTAYMELSSLRSEDTAVYYCARRG | |
| GGSCHFDYWGQGTLVTVSSGGGGSGGGGSGGGGS | |
| EIVLTQSPGTLSLSPGERATLSCRASQSVSSSYL | |
| AWYQQKPGQAPRLLIYGASSRATGIPDRFSGSGS | |
| GTDFTLTISRLEPEDFAVYYCQQYDADPLTFGQG | |
| TKVEIKRTASGAAAAHHHHHH | |
| MAEVQLLESGGGLVQPGGSLRLSCAASGFTFSSY | (SEQ ID NO: 9) |
| AMSWVRQAPGKGLEWVSAISGSGGSTYYADSVKG | |
| RFTISRDNSKNTLYLQMNSLRAEDTAVYYCARDG | |
| SDNDYFDYWGQGTLVTVSSGGGGSGGGGSGGGGS | |
| EIVLTQSPGTLSLSPGERATLSCRASQSVSSSYL | |
| AWYQQKPGQAPRLLIYGASSRATGIPDRFSGSGS | |
| GTDFTLTISRLEPEDFAVYYCQQYASTPPPTFGQ | |
| GTKVEIKRTASGAAAAHHHHHH | |
| MAQVQLVQSGAEVKKPGSSVKVSCKASGGTFSSY | (SEQ ID NO: 10) |
| AISWVRQAPGQGLEWMGGIIPIFGTANYAQKFQG | |
| RVTITADKSTSTAYMELSSLRSEDTAVYYCARDG | |
| GSGNIFDYWGQGTLVTVSSGGGGSGGGGSGGGGS | |
| NIQMTQSPSSLSASVGDRVTITCRASQGISNYLA | |
| WFQQKPGKAPKLLIYDASSLQSGVPSRFSGSGSG | |
| TDFTLTISSLQPEDFATYYCQQYNSTPPTFGQGT | |
| KVEIKRTASGAAAAHHHHHH | |
| MAEVQLLESGGGLVQPGGSLRLSCAASGFTFSSY | (SEQ ID NO: 11) |
| PMSWVRQAPGKGLEWVSAISGSGGSTYYADSVKG | |
| RFTISRDNSKNTLYLQMNSLRAEDTAVYYCARSH | |
| SDSYYFDYWGQGTLVTVSSGGGGSGGGGSGGGGS | |
| EIVLTQSPGTLSLSPGERATLSCRASQSVSSYYL | |
| AWYQQKPGQAPRLLIYDASPRATGIPDRFSGSGS | |
| GTDFTLTISRLEPEXFAVYYCQQYIITPPLTFGQ | |
| GTKVEIKRTASGAAAAHHHHHH | |
| MAEVQLLESGGGLVQPGGSLRLSCAASGFTFSSY | (SEQ ID NO: 12) |
| AMSWVXQAPGKGLEWVSAISGSGGSTYYADSVKG | |
| RFTISRDNSKNTLYLQMNSLRAEXTAVYYCARAG | |
| ATSGDYFDYWGQGTLVTVSSGGGGSGGGGSGGGX | |
| SEIVLTQSPGTLSLSPGERATLSCRASQSVSSSY | |
| LAWYQQKPGQAPRLLIYDASPRATGIPDRFSGSG | |
| SGTDFTLTISRLEPEXFAVYYCQQYIITPPLTFG | |
| QGTKVEIKRTASGAAAAHHHHHH | |
| MAEVQLLESGGGLVQPGGSLRLSCAASGFTFSSY | (SEQ ID NO: 13) |
| RMRWVRQAPGKGLEWVSAISGSGGSTYYADSVKG | |
| RFTISRDNSKNTLYLQMNSLRAEDTAVYYCARDG | |
| SDSGDDFDYWGQGTLVTVSSGGGGSGGGGSGGGG | |
| SDIQMTQSPSSLSASVGDRVTITCRASQGISNYL | |
| AWFQQKPGKAPKSLIYAASSLQSGVPSRFSGSGS | |
| GTDFTLTISSLQPEDFATYYCQQYNSHPLTFGQG | |
| TKVEIKRTASGAAAAHHHHHH | |
| MAQVQLVQSGAEVKKPGSSVKVSCKASGGTFSSY | (SEQ ID NO: 14) |
| AISWVRQAPGQGLEWMGGIIPIFGTANYAQKFQG | |
| RVTITADKSTSTAYMELSSLRSEDTAVYYCARGD | |
| SGDNYYFDYWGQGTLVTVSSGGGGSGGGGSGGGG | |
| SEIVLTQSPGTLSLSPGERATLSCRASQSVSSSY | |
| LAWYQQKPGQAPRLLIYGASSRATGIPDRFSGSG | |
| SGTDFTLTISRLEPEDFAVYYCQQYDYTPPLTFG | |
| QGTKVEIKRTASGAAAAHHHHHH | |
| MAEVQLLESGGGLVQPGGSLRLSCAASGFTFSSY | (SEQ ID NO: 15) |
| AMSWVRQAPGKGLEWVSAISGSGGSTYYADSVKG | |
| RFTISRDNSKNTLYLQMNSLRAEDTAVYYCARGR | |
| RGSRHYYFDYWGQGTLVTVSSGGGGSGGGGSGGG | |
| GSDIQMTQSPSSLSASVGDRVTITCRASQGISNY | |
| LAWFQQKPGKAPKSLIYAASSLQSGVPSRFSGSG | |
| SGTDFTLTISSLQPEDFATYYCQQYAATPPLTFG | |
| QGTKVEIKRTASGAAAAHHHHHH | |
| MAEVQLLESGGGLVQPGGSLRLSCAASGFTFSSY | (SEQ ID NO: 16) |
| AMSWVRQAPGKGLEWVSAISGSGGSTYYADSVKG | |
| RFTISRDNSKNTLYLQMNSLRAEDTAVYYCARDG | |
| SGDNYYYFDYWGQGTLVTVSSGGGGSGGGGSGGG | |
| GSEIVLTQSPGTLSLSPGERATLSCRASQSVSSS | |
| YLAWYQQKPGQAPRLLIYGASSRATGIPDRFSGS | |
| GSGTDFTLTISRLEPEDFAVYYCQQYAAAPPLTF | |
| GQGTKVEIKRTASGAAAAHHHHHH | |
| MAEVQLLESGGGLVQPGGSLRLSCAASGFTFSSY | (SEQ ID NO: 17) |
| AMSWVRQAPGKGLEWVSAISGSGGSTYYADSVKG | |
| RFTISRDNSKNTLYLQMNSLRAEDTAVYYCARDR | |
| GGGGDDYFDYWGQGTLVTVSSGGGGSGGGGSGGG | |
| GSEIVLTQSPGTLSLSPGERATLSCRASQSVSSS | |
| YLAWYQQKPGQAPRLLIYGASSRATGIPDRFSGS | |
| GSGTDFTLTISRLEPEDFAVYYCQQYSSSPPLTF | |
| GQGTKVEIKRTASGAAAAHHHHHH | |
| MAEVQLLESGGGLVQPGGSLRLSCAASGFTFSSY | (SEQ ID NO: 18) |
| AMSWVRQAPGKGLEWVSAISGSGGSTYYADSVKG | |
| RFTISRDNSKNTLYLQMNSLRAEDTAVYYCARCG | |
| SDDSYYYFDYWGQGTLVTVSSGGGGSGGGGSGGG | |
| GSDIQMTQSPSSLSASVGDRVTITCRASQGISNY | |
| LAWFQQKPGKAPKSLIYAASSLQSGVPSRFSGSG | |
| SGTDFTLTISSLQPEDFATYYCQQYSSSPPSTFG | |
| QGTKVEIKRTASGAAAAHHHHHH | |
| MAQVQLVQSGAEVKKPGSSVKVSCKASGGTFSSY | (SEQ ID NO: 19) |
| AISWVRQAPGQGLEWMGGIIPIFGTANYAQKFQG | |
| RVTITADKSTSTAYMELSSLRSEDTAVYYCARDG | |
| GATTGDYSFDYWGQGTLVTVSSGGGGSGGGGSGG | |
| GGSEIVLTQSPGTLSLSPGERATLSCRASQSVSS | |
| SYLAWYQQKPGQAPRLLIYGASSRATGIPDRFSG | |
| SGSGTDFTLTISRLEPEDFAVYYCQQYPSRPLTF | |
| GQGTKVEIKRTASGAAAAHHHHHH | |
| MAQVQLVQSGAEVKKPGSSVKVSCKASGGTFSSY | (SEQ ID NO: 20) |
| AISWVRQAPGQGLEWMGGIIPIFGTANYAQKFQG | |
| RVTITADKSTSTAYMELSSLRSEDTAVYYCARDH | |
| GGSDSDYDFDYWGQGTLVTVSSGGGGSGGGGSGG | |
| GGSEIVLTQSPGTLSLSPGERATLSCRASQSVSS | |
| SYLAWYQQKPGQAPRLLIYGASSRATGIPDRFSG | |
| SGSGTDFTLTISRLEPEDFAVYYCQQYNSTPPLT | |
| FGQGTKVEIKRTASGAAAAHHHHHH | |
| MAEVQLLESGGGLVQPGGSLRLSCAASGFTFSSY | (SEQ ID NO: 21) |
| AMSWVRQAPGKGLEWVSAISGSGGSTYYADSVKG | |
| RFTISRDNSKNTLYLQMNSLRAEDTAVYYCARDG | |
| GVGVSYYFFDYWGQGTLVTVSSGGGGSGGGGSGG | |
| GGSEIVLTQSPGTLSLSPGERATLSCRASQSVSS | |
| SYLAWYQQKPGQAPRLLIYGASSRATGIPDRFSG | |
| SGSGTDFTLTISRLEPEDFAVYYCQQYRSTPPLT | |
| FGQGTKVEIKRTASGAAAAHHHHHH | |
| MAQVQLVQSGAEVKKPGSSVKVSCKASGGTFSSY | (SEQ ID NO: 22) |
| AISWVRQAPGQGLEWMGGIHPISGTANYAQKFQG | |
| RVTITADKSTSTAYMELSSLRSEDTAVYYCARDG | |
| RGRRAAPSPFDYWGQGTLVTVSSGGGGSGGGGSG | |
| GGGSNIQMTQSPSSLSASGGDRVTITCRASQGIS | |
| SDLAWYQQKPGKAPKSLIYAASSLQSGVPSRFSG | |
| SGSGTDFTLTISSLQPEDFATYYCQQYYSNPHTF | |
| GQGTKVEIKRTASGAAAAHHHHHH | |
| MAQVQLVQSGAEVKKPGSSVKVSCKASGGTFSSY | (SEQ ID NO: 23) |
| AISWVRQAPGQGLEWMGGIIPIFGTANYAQKFQG | |
| RVTITADKSTSTAYMELSSLRSEDTAVYYCARGS | |
| SGSNGSNYYYYFDYWGQGTLVTVSSGGGGSGGGG | |
| SGGGGSEIVLTQSPGTLSLSPGERATLSCRASQS | |
| VSSSYLAWYQQKPGQAPRLLIYGASSRATGIPDR | |
| FSGSGSGTDFTLTISRLEPEDFAVYYCQQYNSYP | |
| FTFGQGTKVEIKRTASGAAAAHHHHHH | |
| MAQVQLVQSGAEVKKPGSSVKVSCKASGGTFSSY | (SEQ ID NO: 24) |
| AISWVRQAPGQGLEWMGGIIPIFGTANYAQKFQG | |
| RVTITADKSTSTAYMELSSLRSEDTAVYYCARNG | |
| DGDGDSSYNYNYFDYWGQGTLVTVSSGGGGSGGG | |
| GSGGGGSNIQMTQSPSSLSASVGDRVTITCRASQ | |
| GISNYLAWFQQKPGKAPKSLIYAASSLQSGVPSR | |
| FSGSGSGTDFTLTISSLQPEDFATYYCQQYSSSP | |
| PSTFGQGTKVEIKRTASGAAAAHHHHHH | |

This experiment demonstrates that in vivo phage display is suitable for identifying antibodies that more effectively traverse the mucosal epithelium to enter the blood, spleen and liver than standard phage. The enrichment results can be further improved by optimizing the dosing parameters, including, for example, the titer and volume of the phage administered, speed of dosing, needle gauge, starvation protocols, tissue processing and titering.

### EXAMPLE 2

### Binding to Rat Intestinal Cells

The ability of a clone selected by in vivo phage display to bind rat intestinal cells was tested, using the following protocol.

First, IEC-6 cells previously grown in monolayers were trypsinized and washed twice with PBS. Next 500,000 in 0.1 ml PBS were distributed into each well of a V-bottom polypropylene 96-well plate. To these wells 0.05 of scFv phagemid supernatents (˜1×10¹⁰ phage) were added and allowed to incubate for one hour at 4 degrees. Next, cells were pelleted by centrifugation and then washed three times with 0.180 ml cold PBS. The pellets were then resuspended in 0.05 ml mouse anti-m13 antibody (diluted 1:1000) in PBS/1% BSA and incubated for one hour at 4° C. Next, cells were pelleted by centrifugation and then washed three times with 0.180 ml cold PBS. Following the wash the cells were resuspended in 0.05 ml goat anti-mouse IgG-HRP (diluted 1:1000) antibody in PBS/1% BSA and incubated for one hour at 4° C. -Following this step the cells were again pelleted by centrifugation and then washed three times with 0.180 ml cold PBS. Finally the cells were resuspended in 0.05 ml TMB substrate and developed for 10 minutes at room temperature. The reactions were then terminated by the addition of 0.05 ml stop solution and absorbance 450 nm were measured

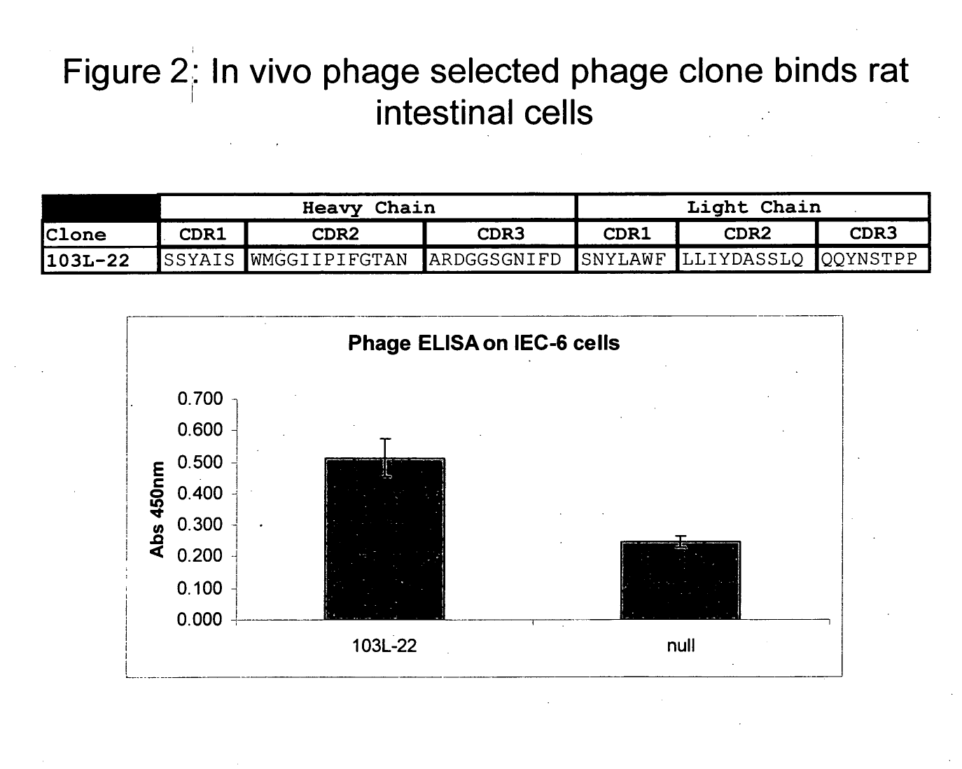

As shown in FIG. 2, the tested clone (SEQ ID NO: ) bound IEC-6 rat intestinal cells.

Although in the foregoing description the invention is illustrated with reference to certain embodiments, it is not so limited. Indeed, various modifications of the invention in addition to those shown and described herein will become apparent to those skilled in the art from the foregoing description and fall within the scope of the appended claims.

All references cited throughout the specification are hereby expressly incorporated by reference.

What is claimed is:

1. A method for identifying molecules capable of translocation through the gastrointestinal tract, comprising:
(a) testing the ability of members of a first repertoire of said molecules to bind to the intestinal epithelium in vitro, and detecting members that are capable of said binding;
(b) testing the ability of members of a second repertoire of said molecules to translocate from the lumenal side of gastrointestinal tissue into the gastrointestinal mucosa or into the blood stream or lymphatic circulation in vivo, and detecting members that are capable of said translocation; and
(c) identifying a member or members detected in step (a) or step (b) as being capable of translocation through the gastrointestinal tract,
wherein steps (a) and (b) may be performed simultaneously or in either order.

2. The method of claim 1 wherein said molecules are selected from the group consisting of antibodies, polypeptides, peptides, polynucleotides, and non-peptide small molecules.

3. The method of claim 2 wherein said molecules are antibodies and said first and second repertoires are antibody repertoires.

4. The method of claim 3 wherein said first and second antibody repertoires are the same.

5. The method of claim 3 wherein said first and second antibody repertoires are different.

6. The method of claim 3 wherein at least one of said first and second antibody repertoires is in the form of a naive human antibody library.

7. The method of claim 3 wherein at least one of said first and second antibody repertoires is in the form of a recombinant, synthetic or semi-synthetic antibody library.

8. The method of claim 3 wherein at least one of said first and second antibody repertoires is in the form of a displayed antibody library.

9. The method of claim 8 wherein the display is selected from the group consisting of phage display, ribosome display, mRNA display, microbial cell display, display on mammalian cells, spore display, viral display, display based on protein-DNA linkage, and microbead display.

10. The method of claim 9 wherein said microbial cell display is yeast cell display.

11. The method of claim 10 wherein at least one of said first and second antibody repertoires is in the form of an antibody phage display library.

12. The method of claim 11 wherein in step (a) the ability of members of the first antibody repertoire to bind an epithelial cell line, intestinal epithelial cells or a marker involved in translocation through intestinal epithelium is tested.

13. The method of claim 12 wherein step (a) is performed by in vitro biopanning.

14. The method of claim 11 wherein said antibody phage display library is a synthetic, semi-synthetic, or recombinant antibody library or a naïve human antibody library.

15. The method of claim 11 wherein said antibody phage display library is a universal antibody library (UAL) or a hyperimmunized murine antibody library.

16. The method of claim 11 wherein members of said antibody phage display library are scFv or Fab fragments.

17. The method of claim 1 wherein only members detected in both step (a) and step (b) are identified as being capable of translocation through the gastrointestinal tract.

18. The method of claim 12 wherein in step (a) said intestinal epithelial cell line is a IEC-6 cell line (ATCC CRL 1592).

19. The method of claim 11 wherein in step (b) members capable of said translocation are detected by in vivo phage display in a non-human animal.

20. The method of claim 19 wherein said non-human animal is a rodent.

21. The method of claim 20 wherein said rodent is a rat or a mouse.

22. The method of claim 19 wherein said non-human animal is a goat or a cow.

23. The method of claim 19 wherein in step (b) the second antibody repertoire is administered to said non-human animal, and one or more antibodies are detected in the blood stream or lymphatic circulation or in the mucosal epithelium of said non-human animal.

24. The method of claim 23 wherein said administration is performed orally or by duodenal cannulation, gut loop model or direct administration into a section of a ligated intestine of said non-human animal.

25. The method of claim 3 wherein said first or second antibody repertoire has at least 10⁶ different members.

26. The method of claim 3 wherein said first or second antibody repertoire has at least 10⁷ different members.

27. The method of claim 3 wherein said first or second antibody repertoire has at least 10⁸ different members.

28. The method of claim 3 wherein said first or second antibody repertoire has at least 10⁹ different members.

29. The method of claim 3 wherein step (a) is performed both with a universal antibody library (UAL) and/or a hyperimmunized murine antibody library.

30. The method of claim 3 wherein step (b) is performed both with a universal antibody library (UAL) and/or a hyperimmunized murine antibody library.

31. The method of claim 3 wherein the member or members detected in step (a) or step (b) as being capable of translocation through the gastrointestinal tract are recovered.

32. The method of claim 3 wherein said antibodies the member or members detected in step (a) or step (b) as being capable of translocation through the gastrointestinal tract are pooled.

33. The method of claim 3 wherein said member or members identified in step (c) are further characterized by binding, internalization and/or transport assays.

34. The method of claim 33 wherein said binding and/or internalization is detected by flow cytometry or ELISA.

35. The method of claim 33 wherein said transport assay comprises passage through confluent epithelial cells immobilized on a permeable support.

36. The method of claim 3 further comprising the step of sequencing the member or members identified in step (c).

37. The method of claim 36 further comprising the step of identifying sub-sequences or residues within the sequence obtained that participate in translocation through the gastrointestinal tract.

38. The method of claim 37 further comprising the step of synthesizing a peptide comprising said sequences.

39. The method of claim 36 further comprising the step of cloning and expressing said member or members.

40. The method of claim 39 further comprising the step of purifying said member or members.

41. The method of claim 40 further comprising the step of characterizing the purified member or members by binding, internalization and/or transport assays.

42. The method of claim 38 further comprising the step of optimizing said member or members.

43. The method of claim 42 wherein said member or members are optimized for stability, affinity and/or specificity.

44. The method of claim 43 wherein said stability is gastrointestinal stability.

45. The method of claim 43 wherein said optimization is performed by mutagenesis.

46. The method of claim 45 wherein said mutagenesis is performed bylook through mutagenesis (LTM), saturation mutagenesis or PCR-based mutagenesis.

47. The method of claim 46 wherein said PCR-based mutagenesis is error prone PCR.

48. The method of claim 44 wherein the optimization of gastrointestinal stability comprises determining site or sites of proteolysis of said antibody, and perform mutagenesis at or around the residues participating in said proteolysis to improve gastrointestinal stability.

49. The method of claim 3 wherein in step (b) said antibody is detected in the systemic circulation.

50. The method of claim 49 wherein said antibody is detected in a therapeutically effective level.

51. The method of claim 45 wherein said mutagenesis is performed at amino acid residues not shared by antibodies capable of translocation through the gastrointestinal tract.

52. The method of claim 45 wherein said mutagenesis is performed using the residues shared by antibodies capable of translocation through the gastrointestinal tract as a scaffold.

53. A collection of sequences shared by antibodies identified as being capable of translocation through the gastrointestinal tract by the method of claim 1 or consensus sequences thereof.

54. An antibody identified by the method of claim 1.

55. The antibody of claim 54 comprising a CDR of an antibody sequence selected from the group consisting of SEQ ID NOs: 1 to 24.

56. The antibody of claim 54 comprising a sequence selected from the group consisting of SEQ ID NOs: 1 to 24.

57. A chimeric molecule comprising a sequence of the collection of claim 53 or the antibody of claim 54, or a fragment thereof, and a molecule to be delivered through the gastrointestinal tract.

58. The chimeric molecule of claim 57 wherein the molecule to be delivered is an antibody.

59. The chimeric molecule of claim 57 wherein the molecule to be delivered is a protein.

60. The chimeric molecule of claim 57 wherein the molecule to be delivered is a peptide.

61. The chimeric molecule of claim 57 wherein the molecule to be delivered is a non-peptide small molecule.

62. A pharmaceutical composition comprising the antibody of claim 56 or the chimeric molecule of claim 57.

63. A method for delivering a molecule through the gastrointestinal tract comprising conjugating said molecule to a sequence of the collection of claim 53 or an antibody of claim 54, and administering the conjugate obtained to a cell.

64. The method of claim 63 wherein said administration is in vivo.

65. The method of claim 64 wherein said conjugate is administered to a human subject.

66. A method for increasing translocation of a molecule through the gastrointestinal tract comprising conjugating said molecule to an antibody, an antibody fragment, or a peptide involved in translocation and identified by a method of claim 1, wherein the translocation of said molecule is greater in the form of said conjugate than without conjugation.

67. A method for oral delivery of a molecule that is poorly absorbed from the gastrointestinal tract, comprising conjugating said molecule to an antibody, an antibody fragment, or a peptide identified by a method of claim 1.

68. The method of claim 68 wherein the poorly absorbing molecule is an antibody or an antibody fragment


SEQUENCE LISTING (24 sequences)

SEQ ID NO: 1 - protein, 256 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARAGSTAFDYWGQGTLVTVSSGGGGSGGGGSGGGGSNIQMTQSPSSLSASVGDRVTITCRASQGISNYLAWFQQKPGKAPKSLIYAASSLQSGVPSRFSGSGSGTDFTLTISSLQPEDFATYYCQQYNRPPRTFGQGTKVEIKRTASGAAAAHHHHHH

SEQ ID NO: 2 - protein, 257 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARGGSGGFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYASTPVTFGQGTKVEIKRTASGAAAAHHHHHH

SEQ ID NO: 3 - protein, 256 aa, Artificial Sequence
  Antibody Sequence
MAQVQLVQSGAEVKKPGSSVKVSCKASGGTFSSYTMSWVRQAPGQGLEWMGDINPNNGTANYAQKFQGRVTITADKSTSTAYMELSSLRSEDTAVYYCARGRAATFDYWGQGTLVTVSSGGGGSGGGGSGGGGSNIQMTQSPSSLSASVGDRVTITCRASQGISSYLDWYQQKPGKAPKLLIYHASYLQSGVPSRFSGSGSGTDFTLTISSLQPEDFATYYCQQYNIIPITFGQGTKVEIKRTASGAAAAHHHHHH

SEQ ID NO: 4 - protein, 258 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARRGRGRFDYWGQGTLVTVSSGGGGSGGGGSGGGGSEIVLTQSPGTLSLSPGERATLSCRASQSVSSAYLAWYQQKPGQAPRLLIYGASSRATGIPDRFSGSGSGTDFTLTISRLEPEDFAVYYCQQYAAAPPPTFGQGTKVEIKRTASGAAAAHHHHHH

SEQ ID NO: 5 - protein, 259 aa, Artificial Sequence
  Antibody Sequence
  VARIANT 69, 110, 113, 120, 198, 221: Xaa = Any Amino Acid
MAEVQLLESGGGLVQPGGSLRLSCAASGFTFSSYDMNWVRQAPGKGLEWVSAISGSGGSTYYADSVKGXFTISRDNSKNTLYLQMNSLRAEDTAVYYCARVIGVVFFDFXYWXQGTLVTXSSGGGGSGGGGSGGGGSDIQMTQSPSSLSASVGDRVTITCRASQGISSYLTWYQQKPGKAPKSLIYAASSLQSGVPSXFSGSGSGTDFTLTISSLQPEDFXTYYCQQYNSNPLTFGQGTKVEIKRTASGAAAAHHHHHH

SEQ ID NO: 6 - protein, 259 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARGDSSGDDFDYWGQGTLVTVSSGGGGSGGGGSGGGGSEIVLTQSPGTLSLSPGERATLSCRASQSVSNSYLAWYQQKPGQAPRLLIYGASPRATGIPDRFSGSGSGTDFTLTISRLEPEDFAVYYCQQYNSTPSTFGQGTKVEIKRTASGAAAAHHHHHH

SEQ ID NO: 7 - protein, 260 aa, Artificial Sequence
  Antibody Sequence
MAQVQLVQSGAEVKKPGSSVKVSCKASGGTFSSYAMAWVRQAPGQGLEWMGDIDPDSGATNYAQKFQGRVTITADKSTSTAYMELSSLRSEDTAVYYCARPGARAHSFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYHPPPPPTFGQGTKVEIKRTASGAAAAHHHHHH

SEQ ID NO: 8 - protein, 259 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARRGGGSCHFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYDADPLTFGQGTKVEIKRTASGAAAAHHHHHH

SEQ ID NO: 9 - protein, 260 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARDGSDNDYFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYASTPPPTFGQGTKVEIKRTASGAAAAHHHHHH

SEQ ID NO: 10 - protein, 258 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARDGGSGNIFDYWGQGTLVTVSSGGGGSGGGGSGGGGSNIQMTQSPSSLSASVGDRVTITCRASQGISNYLAWFQQKPGKAPKLLIYDASSLQSGVPSRFSGSGSGTDFTLTISSLQPEDFATYYCQQYNSTPPTFGQGTKVEIKRTASGAAAAHHHHHH

SEQ ID NO: 11 - protein, 260 aa, Artificial Sequence
  Antibody Sequence
MAEVQLLESGGGLVQPGGSLRLSCAASGFTFSSYPMSWVRQAPGKGLEWVSAISGSGGSTYYADSVKGRFTISRDNSKNTLYLQMNSLRAEDTAVYYCARSHSDSYYFDYWGQGTLVTVSSGGGGSGGGGSGGGGSEIVLTQSPGTLSLSPGERATLSCRASQSVSSYYLAWYQQKPGQAPRLLIYGASYRATGIPDRFSGSGSGTDFTLTISRLEPEDFAVYYCQQYDDDPPHTFGQGTKVEIKRTASGAAAAHHHHHH

SEQ ID NO: 12 - protein, 261 aa, Artificial Sequence
  Antibody Sequence
  VARIANT 40, 92, 136, 220: Xaa = Any Amino Acid
MAEVQLLESGGGLVQPGGSLRLSCAASGFTFSSYAMSWVXQAPGKGLEWVSAISGSGGSTYYADSVKGRFTISRDNSKNTLYLQMNSLRAEXTAVYYCARAGATSGDYFDYWGQGTLVTVSSGGGGSGGGGSGGGXSEIVLTQSPGTLSLSPGERATLSCRASQSVSSSYLAWYQQKPGQAPRLLIYDASPRATGIPDRFSGSGSGTDFTLTISRLEPEXFAVYYCQQYIITPPLTFGQGTKVEIKRTASGAAAAHHHHHH

SEQ ID NO: 13 - protein, 259 aa, Artificial Sequence
  Antibody Sequence
MAEVQLLESGGGLVQPGGSLRLSCAASGFTFSSYRMRWVRQAPGKGLEWVSAISGSGGSTYYADSVKGRFTISRDNSKNTLYLQMNSLRAEDTAVYYCARDGSDSGDDFDYWGQGTLVTVSSGGGGSGGGGSGGGGSDIQMTQSPSSLSASVGDRVTITCRASQGISNYLAWFQQKPGKAPKSLIYAASSLQSGVPSRFSGSGSGTDFTLTISSLQPEDFATYYCQQYNSHPLTFGQGTKVEIKRTASGAAAAHHHHHH

SEQ ID NO: 14 - protein, 261 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARGDSGDNYYFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYDYTPPLTFGQGTKVEIKRTASGAAAAHHHHHH

SEQ ID NO: 15 - protein, 261 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARGRRGSRHYYFDYWGQGTLVTVSSGGGGSGGGGSGGGGSDIQMTQSPSSLSASVGDRVTITCRASQGISNYLAWFQQKPGKAPKSLIYAASSLQSGVPSRFSGSGSGTDFTLTISSLQPEDFATYYCQQYAATPPLTFGQGTKVEIKRTASGAAAAHHHHHH

SEQ ID NO: 16 - protein, 262 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARDGSGDNYYYFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYAAAPPLTFGQGTKVEIKRTASGAAAAHHHHHH

SEQ ID NO: 17 - protein, 262 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARDRGGGGDDYFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYSSSPPLTFGQGTKVEIKRTASGAAAAHHHHHH

SEQ ID NO: 18 - protein, 261 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARCGSDDSYYYFDYWGQGTLVTVSSGGGGSGGGGSGGGGSDIQMTQSPSSLSASVGDRVTITCRASQGISNYLAWFQQKPGKAPKSLIYAASSLQSGVPSRFSGSGSGTDFTLTISSLQPEDFATYYCQQYSSSPPSTFGQGTKVEIKRTASGAAAAHHHHHH

SEQ ID NO: 19 - protein, 262 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARDGGATTGDYSFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYPSRPLTFGQGTKVEIKRTASGAAAAHHHHHH

SEQ ID NO: 20 - protein, 263 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARDHGGSDSDYDFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYNSTPPLTFGQGTKVEIKRTASGAAAAHHHHHH

SEQ ID NO: 21 - protein, 263 aa, Artificial Sequence
  Antibody Sequence
MAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCARDGGVGVSYYFFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYRSTPPLTFGQGTKVEIKRTASGAAAAHHHHHH

SEQ ID NO: 22 - protein, 262 aa, Artificial Sequence
  Antibody Sequence
MAQVQLVQSGAEVKKPGSSVKVSCKASGGTFSSYAISWVRQAPGQGLEWMGGIHPISGTANYAQKFQGRVTITADKSTSTAYMELSSLRSEDTAVYYCARDGRGRRAAPSPFDYWGQGTLVTVSSGGGGSGGGGSGGGGSNIQMTQSPSSLSASGGDRVTITCRASQGISSDLAWYQQKPGKAPKSLIYAASSLQSGVPSRFSGSGSGTDFTLTISSLQPEDFATYYCQQYYSNPHTFGQGTKVEIKRTASGAAAAHHHHHH

SEQ ID NO: 23 - protein, 265 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARGSSGSNGSNYYYYFDYWGQGTLVTVSSGGGGSGGGGSGGGGSEIVLTQSPGTLSLSPGERATLSCRASQSVSSSYLAWYQQKPGQAPRLLIYGASSRATGIPDRFSGSGSGTDFTLTISRLEPEDFAVYYCQQYNSYPFTFGQGTKVEIKRTASGAAAAHHHHHH

SEQ ID NO: 24 - protein, 266 aa, Artificial Sequence
  Antibody Sequence
MAQVQLVQSGAEVKKPGSSVKVSCKASGGTFSSYAISWVRQAPGQGLEWMGGIIPIFGTANYAQKFQGRVTITADKSTSTAYMELSSLRSEDTAVYYCARNGDGDGDSSYNYNYFDYWGQGTLVTVSSGGGGSGGGGSGGGGSNIQMTQSPSSLSASVGDRVTITCRASQGISNYLAWFQQKPGKAPKSLIYAASSLQSGVPSRFSGSGSGTDFTLTISSLQPEDFATYYCQQYSSSPPSTFGQGTKVEIKRTASGAAAAHHHHHH